(19) United States
(12) Patent Application Publication
(10) Pub. No.: US 2014/0326713 A1
(43) Pub. Date: Nov. 6, 2014

(54) HEATING DEVICE FOR AN ELECTRIC HAIR DRYER

(71) Applicant: Jianfeng Chen, Yuyao City (CN)

(72) Inventor: Jianfeng Chen, Yuyao City (CN)

(73) Assignee: Ningbo Taili Electric Co., Ltd., Yuyao City (CN)

(21) Appl. No.: 13/580,060

(22) PCT Filed: Feb. 9, 2012
(86) PCT No.: PCT/CN12/70973

§ 371 Date: Jul. 19, 2014

(30) Foreign Application Priority Data
Jan. 16, 2012 (CN) 201210012446.7

(51) Int. Cl. H05B 3/42

(52) U.S. Cl. CPC H05B 3/42
USPC 219/539

(57) ABSTRACT

The invention discloses a heating device for an electric hair dryer, said heating device comprising heating wires (2) and mica sheets (1); said heating wires (2) are folded to be corrugation, such that the distance between peaks is 5.0 mm or more; and said heating wires (2) are zigzag wound on the mica sheets (1) in stepped, laminated and beveled arrangements. The heating device for the electric hair dryer of the present invention, by deepening corrugation and employing zigzag arrangement, increases the clearance between heating wires, areas of heat dispersion and windward surface, shortens the structure of the heating device to save the cost, improves the heat dispersion of the heating device, and addresses a series of problems, such as less power of the electric hair dryer, larger bulk, higher air temperature, less air volume, turning red of heating wires, the contact of the wires, so as to provide an electric hair dryer having advantages of refinement and strong heat dispersion.

### TECHNICAL FIELD

The present invention relates to a hairdressing equipment field, and more particularly to a heating device for an electric hair dryer.

### BACKGROUND ART

A current heating device for an electric hair dryer comprises heating wires and mica sheets. Mica sheets are typically shaped of substantial cylinder, so that a coil formed by winding the heating wires is in a parallel state. The heating wires are in such an overlapped state that areas of windward surface and heat sinking surface are small, which results in uneven heat dispersion. Usually, the inconsistency between the pursuance of the refinement of the product and inner component causes a series of quality problems, such as less power, larger bulk, higher air temperature, less air volume, turning red of heating wires, the contact of the wires and a series of other serious defects.

### CONTENTS OF THE INVENTION

(1) Technical Problem

A technical problem to be solved of the present invention is to improve the heat dispersion of heating device for the electric hair dryer, increase the area of windward surface and reduce the structure of the heating device, so as to provide an electric hair dryer having advantages of refinement and strong heat dispersion.

(2) Technical Solution

To address above problems, the present invention provides a heating device for an electric hair dryer, said heating device comprising heating wires and mica sheets; said heating wires are folded to be corrugation, such that the distance between peaks is 5.0 mm or more. In the case of constant power, said heating wires are zigzag wound on the mica sheets in stepped, laminated and beveled arrangements, and heating wires between layers thereof are zigzag arranged. The length of mica sheet may be greatly shortened to reduce the cost of product and make the air dryer more exquisite. Such a structure of the heating device can increase the clearance between heating wires, heat dispersion area and windward surface to a maximum degree, so as to suppress the occurrence of higher air temperature, less air volume, turning red of heating wires and the contact of the wires, and improve the heat dispersion of heating device for the electric hair dryer.

In above heating device for the electric hair dryer, corrugations folded by said heating wires are in form of U-shape or V-shape, so as to increase the area of heat dispersion.

In above heating device for the electric hair dryer, the stepped arrangement of said heating wires includes steps which are arranged on the contact surfaces between mica sheets and heating wires; the laminated arrangement of said heating wires includes recesses which have different depth and which are arranged on the contact surfaces between mica sheets and heating wires; the beveled arrangement of said heating wires includes bevels which are arranged on the contact surfaces between mica sheets and heating wires. The increment of arrangements of multi-layer recesses, steps and bevels can make heating device increase in clearance between heating wires, the area of heat dispersion and windward surface, so as to prevent the heating wires from contacting.

In above heating device for the electric hair dryer, the structure of said mica sheets may be in form of triangle, hexagon, crisscross, octagon, I-shape and circularity.

In above heating device for the electric hair dryer, said heating wires between layers thereof are up-downward or left-rightward zigzag arranged, so as to increase the areas of heat dispersion and windward surface of heating wires.

(3) Technical Effect

The heating device for the electric hair dryer of the present invention, by deepening corrugation and employing zigzag arrangement, increases the clearance between heating wires, areas of heat dispersion and windward surface, shortens the structure of the heating device to save the cost, improves the heat dispersion of the heating device, and addresses a series of problems, such as less power of the electric hair dryer, larger bulk, higher air temperature, less air volume, turning red of heating wires, the contact of the wires, so as to provide an electric hair dryer having advantages of refinement and strong heat dispersion.

### DESCRIPTION OF FIGURES

FIG. 1 is a front view of a heating device for an electric hair dryer according to the present invention;

FIG. 2 is a left view of a heating device for an electric hair dryer according to the present invention;

FIG. 3 is an enlarged view of circle A in FIG. 1, showing the heating wires in a left-right arrangement;

FIG. 4 is an enlarged view of circle A in FIG. 1, showing the heating wires in an up-down arrangement;

FIG. 5 is an enlarged view of circle B in FIG. 2;

FIG. 6 shows U-shaped corrugation folded by the heating wires of the present invention; and

FIG. 7 shows V-shaped corrugation folded by the heating wires of the present invention.

In the drawings, reference numerals and their respective parts are as follow: mica sheet 1, heating wires 2, and recess 3.

### MODE OF CARRYING OUT THE INVENTION

Special embodiments of the invention will be described in detail with reference to drawings and examples. The following embodiments are intended to explain the present invention rather than to limit the scope of the invention.

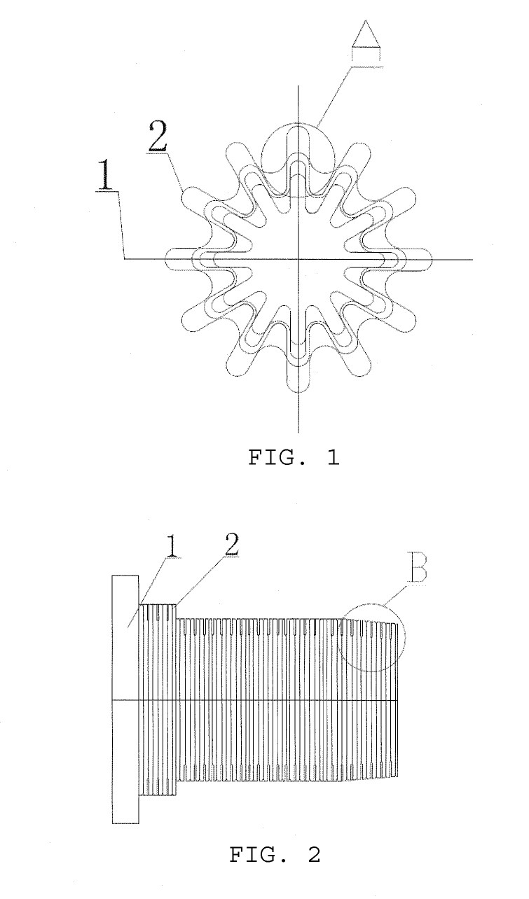

FIGS. 1 and 2 show the heating device for the hair dryer according to the present invention. The heating device comprises heating wires 2 and mica sheets 1; said heating wires 2 are folded to be corrugation, such that the distance between peaks is 5.0 mm or more. In the case of constant power, said heating wires 2 are zigzag wound on the mica sheets 1 in stepped, laminated and beveled arrangements, and heating wires 2 between layers thereof are zigzag arranged. The length of mica sheet 1 may be greatly shortened to reduce the cost of product and make the air dryer more exquisite. Such a structure of the heating device can increase the clearance between heating wires 2, heat dispersion area and windward surface, so as to suppress the occurrence of higher air temperature, less air volume, turning red of heating wires and the contact of the wires, and improve the heat dispersion of heating device for the electric hair dryer.

As shown in FIGS. 6 and 7, in above heating device for the electric hair dryer, corrugations folded by said heating wires 2 are in form of U-shape or V-shape, so as to increase the area of heat dispersion.

In above heating device for the electric hair dryer, the stepped arrangement of said heating wires 2 includes steps which are arranged on the contact surfaces between mica sheets 1 and heating wires 2; the laminated arrangement of said heating wires 2 includes recesses 3 which have different depth and which are arranged on the contact surfaces between mica sheets 1 and heating wires 2; the beveled arrangement of said heating wires 2 includes bevels which are arranged on the contact surfaces between mica sheets 1 and heating wires 2. As shown in FIG. 5, the increment of arrangements of multi-layer recesses, steps and bevels can make heating device increase in clearance between heating wires 2, the area of heat dispersion and windward surface, so as to prevent the heating wires from contacting.

In above heating device for the electric hair dryer, the structure of said mica sheets 1 may be in form of triangle, hexagon, crisscross, octagon, I-shape and circularity.

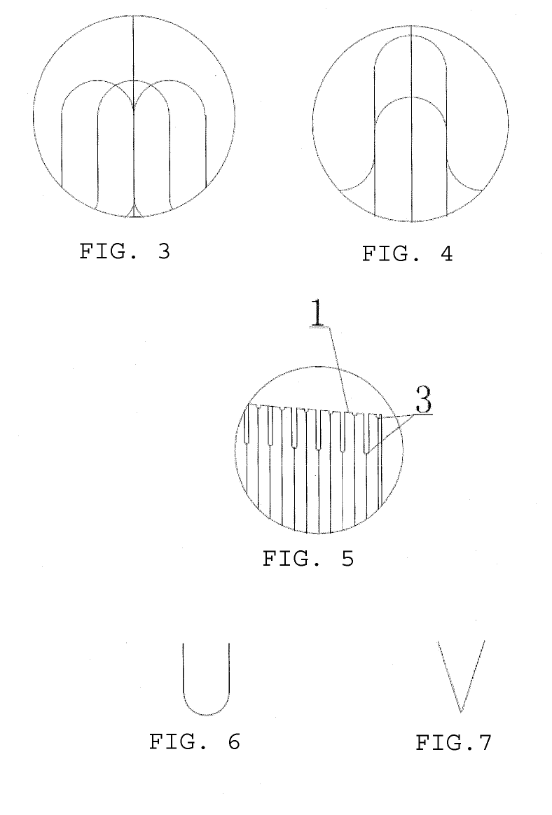

As shown in FIGS. 3 and 4, in above heating device for the electric hair dryer, said heating wires between layers thereof are up-downward or left-rightward zigzag arranged, so as to increase the areas of heat dispersion and windward surface of heating wires.

When the heating wires 2 are winding onto the mica sheets 1, the mica sheets 1 in form of crisscross may be arranged to be inclined step. The heating wires folded into U-shaped corrugation with depth of more than 5 mm are wound on the mica sheets 1, so that the positions between adjacent heating wires 2 are up-downward zigzag arranged.

When the heating wires 2 are winding onto the mica sheets 1, two recesses 3 with different depth may be provided on the mica sheets 1 in form of crisscross. The heating wires folded into V-shaped corrugation with depth of more than 5 mm are wound on the two recesses 3 of mica sheets 1, so that the positions between adjacent heating wires 2 are left-rightward zigzag arranged.

The heating device for the electric hair dryer of the present invention, by deepening corrugation and employing zigzag arrangement, increases the clearance between heating wires, areas of heat dispersion and windward surface, shortens the structure of the heating device to save the cost, improves the heat dispersion of the heating device, and addresses a series of problems, such as less power of the electric hair dryer, larger bulk, higher air temperature, less air volume, turning red of heating wires, the contact of the wires, so as to provide an electric hair dryer having advantages of refinement and strong heat dispersion.

Preferred embodiments of the invention have been described above. It should be understood that modifications and variations will readily made to those skilled in the art without departing from the technical principles of the invention. Thus, these modifications and variations should be considered to fall within the scope of the invention.

1-5. (canceled)

6. A heating device for an electric hair dryer, wherein the heating device comprises heating wires and mica sheets; the heating wires are folded to be corrugation, such that the distance between peaks is 5.0 mm or more; and the heating wires are zigzag wound on the mica sheets in stepped, laminated and beveled arrangements, heating wires between layers thereof being zigzag arranged; corrugations folded by the heating wires are in form of U-shape or V-shape; the stepped arrangement of the heating wires comprises steps which are arranged on the contact surfaces between mica sheets and heating wires; the laminated arrangement of the heating wires comprises recesses which have different depth and which are arranged on the contact surfaces between mica sheets and heating wires; the beveled arrangement of the heating wires comprises bevels which are arranged on the contact surfaces between mica sheets and heating wires; the structure of the mica sheets is in form of triangle, hexagon, crisscross, octagon, I-shape and circularity; the heating wires between layers thereof are up-downward or left-rightward zigzag arranged.

7. A heating device for an electric hair dryer, wherein the heating device comprises heating wires and mica sheets; the heating wires are folded to be corrugation, such that the distance between peaks is 5.0 mm or more; and the heating wires are zigzag wound on the mica sheets in stepped, laminated and beveled arrangements, heating wires between layers thereof being zigzag arranged.

8. The heating device for the electric hair dryer according to claim 7, wherein corrugations folded by the heating wires are in form of U-shape or V-shape.

9. The heating device for the electric hair dryer according to claim 7, wherein the stepped arrangement of the heating wires comprises steps which are arranged on the contact surfaces between mica sheets and heating wires; the laminated arrangement of the heating wires comprises recesses which have different depth and which are arranged on the contact surfaces between mica sheets and heating wires; the beveled arrangement of the heating wires comprises bevels which are arranged on the contact surfaces between mica sheets and heating wires.

10. The heating device for the electric hair dryer according to claim 7, wherein the structure of the mica sheets is in form of triangle, hexagon, crisscross, octagon, I-shape and circularity.

11. The heating device for the electric hair dryer according to claim 7, wherein the heating wires between layers thereof are up-downward or left-rightward zigzag arranged.

12. The heating device for the electric hair dryer according to claim 8, wherein the stepped arrangement of the heating wires comprises steps which are arranged on the contact surfaces between mica sheets and heating wires; the laminated arrangement of the heating wires comprises recesses which have different depth and which are arranged on the contact surfaces between mica sheets and heating wires; the beveled arrangement of the heating wires comprises bevels which are arranged on the contact surfaces between mica sheets and heating wires.

13. The heating device for the electric hair dryer according to claim 11, wherein the heating wires between layers thereof are up-downward or left-rightward zigzag arranged.

14. A heating device for an electric hair dryer, wherein the heating device comprises heating wires and mica sheets; the heating wires are folded to be corrugation, such that the distance between peaks is 5.0 mm or more; the heating wires are zigzag wound on the mica sheets 1 in stepped, laminated and beveled arrangements, and heating wires between layers thereof are zigzag arranged; the length of mica sheet is greatly shortened to reduce the cost of product and make the air dryer more exquisite; corrugations folded by the heating wires are in form of U-shape or V-shape; the stepped arrangement of the heating wires comprises steps which are arranged on the contact surfaces between mica sheets and heating wires; the laminated arrangement of the heating wires comprises recesses which have different depth and which are arranged on the contact surfaces between mica sheets and heating wires; the beveled arrangement of the heating wires comprises bevels which are arranged on the contact surfaces between mica sheets and heating wires; the structure of the mica sheets is in form of triangle, hexagon, crisscross, octagon, I-shape and circularity; the heating wires between layers thereof are up-downward or left-rightward zigzag arranged; when the heating wires are winding onto the mica sheets, the mica sheets in form of crisscross is arranged to be inclined step; the heating wires folded into U-shaped corrugation with depth of more than 5 mm are wound on the mica sheets, so that the positions between adjacent heating wires are up-downward zigzag arranged; two recesses with different depth may be provided on the mica sheets in form of crisscross; the heating wires folded into V-shaped corrugation with depth of more than 5 mm are wound on the two recesses of mica sheets 1, so that the positions between adjacent heating wires are left-rightward zigzag arranged.
